(19) United States
(12) Patent Application Publication
(10) Pub. No.: US 2019/0145467 A1
(43) Pub. Date: May 16, 2019

(54) CARBONITRIDING OF UNIVERSAL JOINT BUSHES

(71) Applicant: Schaeffler Technologies AG & Co. KG, Herzogenaurach (DE)

(72) Inventors: Martin Kruppa, Herzogenaurach (DE); Sven Lachnit, Herzogenaurach (DE)

(73) Assignee: Schaeffler Technologies AG & Co. KG, Herzogenaurach (DE)

(21) Appl. No.: 16/097,952

(22) PCT Filed: Apr. 12, 2017
(86) PCT No.: PCT/DE2017/100300

§ 371 Date: Oct. 31, 2018

(30) Foreign Application Priority Data
Jun. 3, 2016 (DE) 10 2016 209 782.2

(51) Int. Cl. F16D 3/38; F16D 3/41; F16C 33/78

(52) U.S. Cl. CPC F16D 3/385; F16D 3/41; F16C 2361/41; F16D 2250/0038; F16C 33/7809

(57) ABSTRACT

Universal joint bushes for universal joints are disclosed, as well as methods of making or treating the universal joint bushes. The universal joint bush may include an outer ring, which has a peripheral layer (R) formed by at least one measure for diffusing an element into regions of the universal joint bush near the surface. The peripheral layer (R) of the outer ring may include nitrogen. A method for producing a universal joint bush having a nitrogen-containing peripheral layer (R) may include preparing a universal joint bush made from a case-hardened steel and diffusing, via a thermochemical treatment, nitrogen into regions of the universal joint bush that are close to the surface in order to form the nitrogen-containing peripheral layer (R). The thermochemical treatment may be carried out in a temperature range of at least 800° C.

### CROSS-REFERENCE TO RELATED APPLICATIONS

This application is the U.S. National Phase of PCT Appln. No. PCT/DE2017/100300 filed Apr. 12, 2017, which claims priority to DE 10 2016 209 782.2 filed Jun. 3, 2016, the entire disclosures of which are incorporated by reference herein.

### TECHNICAL FIELD

The disclosure relates to a universal joint bush for universal joints, for example, for use in drive shafts and steering shafts and to a method for producing a universal joint bush.

### BACKGROUND

Universal joint bushes are usually used in universal joints of an articulated shaft, wherein the universal joint is arranged between two shafts aligned at a bending angle.

In a design of this kind, each shaft is normally provided with a joint yoke at the end. Furthermore, a commercially available universal joint comprises four journals offset by 90° relative to one another, which connect the joint yokes to one another, wherein two journals are assigned to each joint yoke. In this case, the journals are each inserted in pairs into the joint yokes by a universal joint bush in combination with a needle roller and cage assembly as a radial bearing.

It is conventional for the universal joint bushes known and used in the prior art to be case hardened. However, these are subject to increased wear at small pivoting angles and simultaneously high pivoting frequencies, especially on the part of the rolling element race, on which needles of a needle roller and cage assembly roll within a universal joint bush. This results in bearing damage, which necessitates replacement of the universal joint bushes.

### SUMMARY

It is therefore an object of the present disclosure to specify a universal joint bush, the bush body or the outer ring of which has optimized wear protection or wear resistance. It is furthermore an object of the present disclosure to specify a method for producing a universal joint bush in which the bush body or the outer ring of the universal joint bush has optimized wear resistance as a result.

According to the disclosure, these objects may be achieved by the features of the independent patent claims. Further advantageous developments may form the subject matter of the dependent claims.

According to the disclosure, in a first aspect, a universal joint bush for universal joints for use in drive shafts and steering shafts has an outer ring. Needles of a needle roller and cage assembly preferably roll on said outer ring, thereby enabling the universal joint bush to rotate about a journal of a universal joint, for example. Consequently, the outer ring thus preferably forms a rolling element race, e.g. for a needle bearing.

It is advantageous if the outer ring has a peripheral layer formed by at least one measure for diffusing an element into regions of the universal joint bush that are near the surface. It is advantageous here if the peripheral layer of the outer ring comprises nitrogen. In this way, the performance of universal joint bushes can be enhanced by nitrogen (or by carbonitriding).

By virtue of the formation of a nitrogen-containing peripheral layer, the universal joint bush according to the disclosure has an excellent property profile, both in respect of its mechanical properties, such as surface hardness, wear resistance, rolling fatigue strength etc. Furthermore, the nitrogen-enriched peripheral layer has the effect of better retention of hardness and thus additional wear protection/wear resistance of the race or rolling element race and hence a longer service life.

According to the disclosure, the nitrogen-containing peripheral layer is formed by at least one measure for diffusing nitrogen into regions of the universal joint bush that are near the surface. Depending on the respective process parameters used in the context of the at least one measure for diffusing nitrogen into regions that are close to the surface, e.g. temperature, pressure, duration, concentration of the nitrogen in a nitrogen atmosphere that may be necessary, it is possible to exert a selective effect on the nitrogen-containing peripheral layer of the universal joint bush which is to be formed or has been formed. In particular, it is possible in this way to influence or control the penetration depth of the nitrogen atoms and the concentration of the nitrogen atoms in the peripheral layer by way of process technology.

It is furthermore advantageous if the nitrogen-containing peripheral layer has a predetermined layer thickness, such as in a range of from 1 μm to 1.5 mm, in particular in a range of from 1 μm to 0.3 mm, preferably in a range of from 1 to 50 μm. Of course, other predetermined layer thicknesses are possible. Here, the predetermined layer thickness can preferably vary, depending on the wall thickness of the universal joint bush. It is advantageous here if a layer thickness of at least 1.5 mm is achieved in the case of a wall thickness of 6 mm, for example, whereas it is advantageous if a layer thickness of at least 30 μm is achieved in the case of a wall thickness of 0.5 mm, for example. In a comparison between two universal joint bushes with different wall thicknesses, it is advantageous if the universal joint bush with the comparatively smaller wall thickness has a peripheral layer thickness which is likewise smaller in comparison with the other universal joint bush.

The predetermined layer thickness, in particular the abovementioned ranges, has the advantage of offering adequate wear protection or wear resistance. Accordingly, the universal joint bush according to the disclosure can absorb the same mechanical forces as a conventional universal joint bush with the aid of the predetermined layer thickness, for example, although a universal joint bush enriched with nitrogen in the peripheral layer has a far longer service life.

In the context of the predetermined layer thickness mentioned, it may furthermore be mentioned that this can be set by a suitable choice of process and suitable process control of the at least one measure for diffusing nitrogen into regions of the universal joint bush that are close to the surface in order to form the nitrogen-containing peripheral layer.

A universal joint bush may have a core, which is surrounded by the peripheral layer. It is advantageous if the peripheral layer has a higher nitrogen content than the core, in particular an increased nitrogen content of at least 0.04%. The abovementioned limit for an increased nitrogen content of at least 0.04% in the peripheral layer compared with the core ideally leads to increased wear resistance and preferably to increased rolling fatigue strength.

It is also advantageous if universal joint bush comprises a case-hardened steel or consists of a case-hardened steel. It is advantageous here if the case-hardened steel DC04, C15, 16MnCr5, 25CrMo4 and/or SCM415 is used. Of course, other case-hardened steels can also be used. Case-hardened steels or the abovementioned steels are outstandingly suitable for optimizing the properties of a universal joint bush that has been deep drawn or even produced by machining.

It is advantageous if the universal joint bush comprises a wall thickness in a range between 0.5 mm and 6 mm. This wall thickness allows simple production by deep drawing or of a machining method.

A second aspect of the disclosure comprises a method for producing a universal joint bush and/or for increasing the wear resistance of a universal joint bush having a nitrogen-containing peripheral layer.

Attention is drawn explicitly to the fact that the features of the universal joint bush as mentioned under the first aspect of the present description can be used individually or in combination with one another in the method that is now described below.

In other words, the features mentioned above under the first aspect of the disclosure relating to a universal joint bush can also be combined here with other features under the second aspect of the disclosure. Of course, this also applies conversely, that is to say that features of the second aspect can be combined with the features of the first aspect.

It is advantageous if the method comprises the following steps.

An advantageous production step comprises preparing a universal joint bush made from a case-hardened steel, in particular from DC04, C15, 16MnCr5, 25CrMo4 and/or SCM415. Of course, other case-hardened steels can also be used. In this context, preparation can comprise deep drawing a blank or a preform to give a universal joint bush but also production of a universal joint bush by machining from a preform, for example. Of course, other production methods are also possible for the creation of the external shape of a universal joint bush.

It is furthermore advantageous if one production step comprises carrying out at least one measure to diffuse nitrogen into regions of the universal joint bush that are close to the surface in order to form the nitrogen-containing peripheral layer. With the aid of this measure, it is possible under suitable conditions to diffuse foreign atoms, in particular nitrogen, into the microstructure of the universal joint bush provided. In this way, the nitrogen-containing peripheral layer can form in those regions of the universal joint bush which are close to the periphery or surface.

Furthermore, diffusing nitrogen into the microstructure of the universal joint bush, in particular into the peripheral layer thereof, leads to a kind of solid-solution hardening, advantageously precisely in the region of the peripheral layer. The change thereby brought about in the existing atomic microstructure of the universal joint bush in the region of the peripheral layer leads to increased hardness. Moreover, other mechanical properties, such as, in particular, wear resistance or rolling fatigue strength, are improved by the formation of a nitrogen-containing peripheral layer. Via the nitrogen-enriched peripheral layer, it is also possible to achieve better retention of hardness and thus a further increase in respect of wear protection/wear resistance of the race or rolling element race of a universal joint bush.

A thermochemical treatment of the universal joint bush is preferably carried out as the measure for the formation of the nitrogen-containing peripheral layer. It is advantageous if the thermochemical treatment is carried out in a temperature range of at least 800° C. The stated thermochemical treatment in said temperature range makes it possible to diffuse foreign atoms, especially nitrogen, into the existing microstructure of the universal joint bush, which preferably comprises a case-hardened steel.

By defining or setting the temperature prevailing in the context of the thermochemical treatment, it is possible to influence the kinetics of the diffusion of nitrogen into the peripheral layer of the universal joint bush. In this way, certain properties of the nitrogen-containing peripheral layer to be formed can be selectively set. Thus, for example, temperature-related influences can affect the dimensional accuracy and/or surface finish or roughness of the universal joint bush, wherein, of course, given a knowledge of these, it is possible to counteract the stated characteristics or to keep them within a tolerable range.

It is furthermore advantageous if the at least one measure for the formation of the nitrogen-containing peripheral layer is carried out in such a way that a nitrogen-containing peripheral layer having a predetermined layer thickness, preferably from 1 μm to 0.3 mm, preferably from 1 to 50 μm, is formed. Here, the predetermined layer thickness can preferably vary, depending on the wall thickness of the universal joint bush. It is advantageous here if a layer thickness of at least 1.5 mm is achieved in the case of a wall thickness of 6 mm, for example, whereas it is advantageous if a layer thickness of at least 30 μm is achieved in the case of a wall thickness of 0.5 mm, for example. In a comparison between two universal joint bushes with different wall thicknesses, it is advantageous if the universal joint bush with the comparatively smaller wall thickness has a peripheral layer thickness which is likewise smaller in comparison with the other universal joint bush.

The predetermined layer thickness, in particular the abovementioned ranges, has the advantage that adequate wear protection is provided. Due to the predetermined layer thickness, produced by the method according to the disclosure for producing a universal joint bush, a universal joint bush can thus absorb the same mechanical forces as a conventionally produced universal joint bush in accordance with a known method. However, the universal joint bush enriched with nitrogen in the peripheral layer, in accordance with the method presented here, has a far longer service life.

It is advantageous if preparation comprises deep drawing or machining, in particular turning or milling, of a preform or a blank, preferably of a formed part. In this way, as a preliminary stage to the manufacture of a universal joint bush, said bush can be prepared before the subsequent step of carrying out at least one measure for diffusing nitrogen into regions of the universal joint bush that are close to the surface in order to form the nitrogen-containing peripheral layer.

It is advantageous if case hardening, preferably with the additional supply of nitrogen, in particular a carbonitriding method and/or plasma nitriding and/or gas nitriding and/or gas carbonitriding, is carried out as the measure for the formation of the nitrogen-containing peripheral layer. These processes can also optionally be combined or carried out in succession.

The plasma nitriding method is conventionally understood to mean diffusing nitrogen into the starting material to be treated.

Gas nitriding is a thermochemical method in which the material to be treated, that is to say, in particular, to be hardened is heated and, at the same time, exposed to a nitrogen-containing gas, e.g. ammonia (NH3), which then leads to the diffusion of nitrogen into the starting material.

Gas carbonitriding enables nitrogen to be diffused into the material to be treated, wherein the material to be treated is additionally exposed to a carbon-containing gas (e.g. CO2), that is to say overall to a gas mixture comprising a nitrogen- and a carbon-containing gas, and appropriately heated.

A carbonitriding method or carbonitriding is preferably understood to mean a thermochemical method in which the peripheral layer of components is advantageously enriched by the diffusion of carbon and/or nitrogen. It is thereby possible to achieve an improvement in the mechanical properties of the peripheral layer of the component.

The carbonitriding method or carbonitriding is advantageously based on a modified case-hardening process, wherein the peripheral layer can preferably be adjusted to the application-specific stress in respect of the microstructural composition by a matched tempering process.

In particular, the carbonitriding method or carbonitriding offers the advantage of increasing surface and peripheral layer hardness, enhancing retention of hardness (=resistance to thermal stress) and improving behavior in the case of sliding wear.

Ideally, the carbonitriding method or carbonitriding acts at the surface of a treated component and within the latter down to the “case hardening depth” (CHD), wherein ideally the core of the component or of the universal joint bush is not affected.

The method of carburizing/carbonitriding or carbonitriding method is illustrated below by way of example in a method sequence, in which method ideally diffusion layers for wear protection are produced on universal joint bushes.

The aim of the carbonitriding method or of carburizing/carbonitriding (thermochemical method) is to produce a high-C (carbon) and/or C+N-martensitic (carbon and nitrogen) and/or N (nitrogen) peripheral layer of great hardness and preferably with better retention of hardness.

During this process, carrier media, e.g. carrier gas+propane+NH4 or plasma (glow fringe) plus CH4 or C2H6, are preferably used.

The use of the carrier media preferably takes place at a temperature of 850° C. to 1050° C., wherein this preferably occurs over a time of 0.5 to 8 hours. The treated universal joint bush is then advantageously cooled in air.

In one example, universal joint bushes treated in this way have case hardening depths (at least 700 HV) of 0.05 mm to several millimeters.

Universal joint bushes which are subjected to a carbonitriding process or to carburizing/carbonitriding are preferably pretreated, preferably by case hardening or hardening and tempering to set the core strength and/or peripheral hardness depth.

Grinding and/or intensive cleaning of the functional surfaces can also be carried out as a pretreatment.

The carbonitriding method or carburizing/carbonitriding can be carried out in various systems, inter alia in continuously operating belt kilns, discontinuously operating chamber furnaces, discontinuously operating plasma systems and/or multi-chamber plasma systems operating in pusher mode, for example.

In the context of the method according to the disclosure which has been presented, it is possible for at least one measure for work hardening, e.g. cold forming, the universal joint bush to be carried out before the at least one measure for the formation of the nitrogen-containing peripheral layer is carried out.

The measures for work hardening a metallic material are preferably taken to include plastic forming of metallic materials at a temperature below the respective recrystallization temperature thereof. In this case, the plastic deformation of the material increases the dislocation density within the respective material, thereby causing an increase in material hardness.

The inventive concept described above will be expressed in different words below.

In simple terms, this concept preferably concerns the improvement of the mechanical properties, especially the wear resistance or wear protection of the race or of the rolling element race and thus a longer service life, of universal joint bushes for the steering and drive train of a vehicle. In this context, the universal joint bushes are generally deep drawn or, alternatively, produced by machining.

The disclosure advantageously starts from a prior art in which known universal joint bushes are case hardened by conventional methods.

With these conventional bushes, there is wear on or of the rolling element race at a small pivoting angle and simultaneously high pivoting frequencies. As a result, bearing damage arises.

The present disclosure therefore preferably starts by addressing the problem of optimizing the bush body or a universal joint bush in respect of wear protection.

Precisely to enhance the performance of universal joint bushes, said bushes or the rolling element race thereof are, according to the disclosure—and in simple terms—carbonitrided or subjected to a carbonitriding process or to carburizing/carbonitriding.

In this case, in contrast with conventional case hardening, nitrogen is preferably additionally supplied to the atmosphere. This brings about better retention of hardness and thus additional wear protection for the race/rolling element race and hence a longer service life of a universal joint bush.

### BRIEF DESCRIPTION OF THE DRAWINGS

The disclosure is explained in greater detail below by illustrative embodiments in conjunction with associated drawings. In these schematic drawings:

FIG. 1 shows a section through a first illustrative embodiment of a universal joint bush;

FIG. 2 shows a section through a second illustrative embodiment of a universal joint bush; and

FIG. 3 shows a section through a third illustrative embodiment of a universal joint bush.

### DETAILED DESCRIPTION

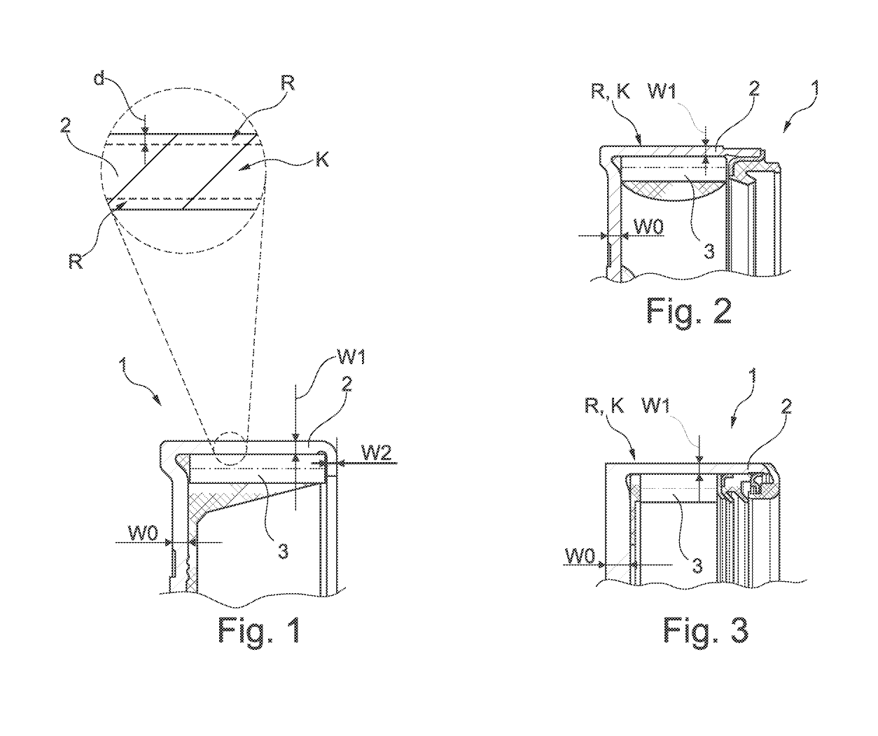

FIG. 1 shows a first illustrative embodiment of a universal joint bush 1 for universal joints for use in drive shafts and steering shafts of a vehicle, wherein the universal joint bush 1 comprises an outer ring 2.

In the example under consideration, the universal joint bush 1 essentially has two vertical components and one horizontal component, which are connected to one another, in particular being formed integrally. Said components together form a cup-shaped universal joint bush 1, wherein the horizontal component illustrated forms the outer ring 2.

Arranged in the region between the three components is a rolling element of a needle bearing or a roller 3 of a needle bearing. As a result, the horizontal component or outer ring 2 thus forms a rolling element race, at least on the inside of the cup-shaped universal joint bush 1, on which race the roller 3 can roll.

For the sake of completeness, it should be mentioned that the said three components of the universal joint bush 1 have different wall thicknesses W0 (wall thickness of the end of the cup-shaped universal joint bush 1), W1 (wall thickness of the outer ring 2 of the universal joint bush 1), W2 (wall thickness of a flanged edge on the open side of the cup-shaped universal joint bush 1)—as illustrated in FIG. 1. Said wall thicknesses W0, W1, W2 or a wall thickness W of the universal joint bush 1 are/is preferably in a range between 0.5 mm and 6 mm.

The outer ring 2 has a peripheral layer R formed by at least one measure for diffusing an element into regions of the universal joint bush 1 that are near the surface. This peripheral layer R of the outer ring 2 comprises nitrogen or is advantageously enriched with an increased proportion of nitrogen.

As illustrated in the enlarged view in FIG. 1, the nitrogen-containing peripheral layer R has a predetermined layer thickness d, said thickness being, in particular, in a range of from 1 μm to 0.3 mm, preferably in a range of from 1 to 50 μm.

The universal joint bush 1 furthermore has a core K, which is surrounded by the peripheral layer R, wherein the peripheral layer ideally has a higher nitrogen content than the core K, in particular an increased nitrogen content of at least 0.04%.

The universal joint bush 1 shown in FIG. 1 can be deep drawn and/or produced by a machining method, for example.

In this case, the universal joint bush 1 comprises a case-hardened steel or consists of a case-hardened steel, wherein DC04, C15, 16MnCr5, 25CrMo4 and/or SCM415 is preferably used as the case-hardened steel. Other grades of steel can, of course, also be used for case-hardened steels.

According to the disclosure, the universal joint bush 1, illustrated in FIG. 1, is produced by a method for producing a universal joint bush 1 and/or for increasing the wear resistance of a universal joint bush 1 having a nitrogen-containing peripheral layer R.

In a specific illustrative embodiment, this method advantageously comprises the following steps.

The first preferred step comprises preparing a universal joint bush 1 made from a case-hardened steel, in particular from DC04, C15, 16MnCr5, 25CrMo4 and/or SCM415. Here, preparation furthermore advantageously comprises deep drawing or machining, in particular turning or milling, of a preform or a blank, preferably of a formed part.

The machined or deep-drawn preform or universal joint bush 1 has a cup-shaped configuration, as illustrated in FIGS. 1-3, for example.

A subsequent or further step comprises carrying out at least one measure to diffuse nitrogen into regions of the universal joint bush 1 that are close to the surface in order to form the nitrogen-containing peripheral layer R.

It is advantageous here if a thermochemical treatment of the universal joint bush 1 is carried out as at least one measure for the formation of the nitrogen-containing peripheral layer R, wherein the thermochemical treatment is preferably carried out in a temperature range of at least 800° C.

It is advantageous if the at least one measure for the formation of the nitrogen-containing peripheral layer R is carried out in such a way that a nitrogen-containing peripheral layer R having a predetermined layer thickness d, preferably from 1 μm to 0.3 mm, preferably from 1 to 50 μm, is formed.

It is advantageous here if case hardening, preferably with the additional supply of nitrogen, in particular a carbonitriding method and/or plasma nitriding and/or gas nitriding and/or gas carbonitriding, is carried out as the at least one measure for the formation of the nitrogen-containing peripheral layer R. With the aid of said methods, nitrogen can be introduced into regions of the universal joint bush 1 that are close to the surface.

The above observations relating to the illustrative embodiment shown in FIG. 1 are likewise applicable to the other illustrative embodiments illustrated in FIGS. 2 and 3.

In contrast to the illustrative embodiment shown in FIG. 1, the universal joint bushes 1 in FIGS. 2 and 3 essentially have a different shape. In particular, these illustrative embodiments in FIGS. 2, 3 dispense with a second vertical component on the open side of the cup-shaped universal joint bush 1.

Common to all the abovementioned illustrative embodiments shown in FIGS. 1 to 3 is the fact that these illustrate universal joint bushes 1 for the steering and drive train of a vehicle.

The above embodiments are summarized once again briefly and in different words below.

It is conventional for traditional universal joint bushes 1 known from the prior art to be case hardened, wherein wear occurs on the rolling element race at small pivoting angles and simultaneously high pivoting frequencies. This result is bearing damage, which necessitates replacement of the universal joint bush.

The present disclosure therefore advantageously starts by addressing the problem of optimizing the bush body or the universal joint bush 1 or the outer ring 2 thereof in respect of wear protection.

In order to achieve optimization and to enhance the performance of universal joint bushes, these may be carbonitrided.

In this case, in contrast with conventional case hardening, nitrogen is additionally supplied to the atmosphere. This brings about better retention of hardness and thus additional wear protection for the race and hence a longer service life.

### LIST OF REFERENCE SIGNS

1 universal joint bush
2 outer ring
3 rolling element/roller of a needle bearing
d layer thickness
K core
R peripheral layer
W0 wall thickness
W1 wall thickness
W2 wall thickness

1. A universal joint bush for universal joints, comprising:
an outer ring, which has a peripheral layer (R) formed by at least one measure for diffusing an element into regions of the universal joint bush near the surface, wherein the peripheral layer (R) of the outer ring comprises nitrogen.

2. The universal joint bush as claimed in claim 1, wherein the nitrogen-containing peripheral layer (R) has a predetermined layer thickness (d) in the range of from 1 to 50 μm.

3. The universal joint bush as claimed in claim 1, wherein the universal joint bush has a core (K), which is surrounded by the peripheral layer (R), wherein the peripheral layer has a nitrogen content of at least 0.04% and the nitrogen content is higher than that of the core (K).

4. The universal joint bush as claimed in claim 1, wherein the universal joint bush comprises a case-hardened steel, wherein the case-hardened steel is selected from the group consisting of DC04, C15, 16MnCr5, 25CrMo4 and SCM415.

5. The universal joint bush as claimed in claim 1, wherein the universal joint bush comprises a wall thickness in a range between 0.5 mm and 6 mm.

6. A method for producing a universal joint bush and/or for increasing the wear resistance of a universal joint bush having a nitrogen-containing peripheral layer (R), comprising the following steps:
preparing a universal joint bush made from a case-hardened steel,
diffusing, via a thermochemical treatment, nitrogen into regions of the universal joint bush that are close to the surface in order to form the nitrogen-containing peripheral layer (R), and
wherein the thermochemical treatment is carried out in a temperature range of at least 800° C.

7. The method as claimed in claim 6, wherein the diffusion is carried out in such a way that a nitrogen-containing peripheral layer (R) having a predetermined layer thickness (d), preferably from 1 to 50 μm, is formed.

8. The method as claimed in claim 6, wherein preparation comprises deep drawing or machining of a preform.

9. The method as claimed in claim 6, wherein the diffusing includes case hardening using a carbonitriding method and/or plasma nitriding and/or gas nitriding and/or gas carbonitriding.
